(19) United States
(12) Patent Application Publication
(10) Pub. No.: US 2026/0366870 A1
(43) Pub. Date: Nov. 19, 2026

(54) Golf Rangefinder

(71) Applicant: Dotty Green Golf, LLC, Framingham, MA (US)

(72) Inventors: Andrew T. Larracey, Ashland, MA (US); Brian Michael ORME, Phoenixville, PA (US); Orlando J. HERNANDEZ, Ewing, NJ (US)

(21) Appl. No.: 19/133,895

(22) PCT Filed: Nov. 29, 2023
(86) PCT No.: PCT/US2023/081632

§ 371 Date: May 29, 2025

Related U.S. Application Data
(60) Provisional application No. 63/385,494, filed on Nov. 30, 2022.

(51) Int. Cl. G01C 3/08; A63B 57/20; A63B 57/30; A63B 57/35; A63B 57/50; A63B 71/06; A63B 102/32

(52) U.S. Cl. CPC G01C 3/08; A63B 57/207; A63B 57/35; A63B 57/353; A63B 57/50; A63B 71/0622; A63B 2071/0694; A63B 2102/32; A63B 2220/20; A63B 2220/805; A63B 2225/74

(57) ABSTRACT

A golf ball rangefinder includes a body and a laser measurement device positioned within the body. The laser measurement devices emits a visible laser light to measure a distance from the golf ball rangefinder to a point where the laser light contacts an external surface. An electronic display is in communication with the laser measurement device and coupled to an external surface of the body. The electronic display displays a visual indication of the measured distance and the laser measurement device has an accuracy of at least +/−1.0 inch.

### CROSS-REFERENCE TO RELATED APPLICATIONS

This application claims the benefit of U.S. Provisional Patent Application No. 63/385,494 filed Nov. 30, 2022 entitled “Golf Rangefinder”, which is incorporated by reference herein in its entirety.

### TECHNICAL FIELD

The present disclosure generally relates to sporting equipment and, specifically, to a golf rangefinder and methods of use thereof for measuring a distance between one or more golf balls and a pin or flag within a golf ball cup.

### SUMMARY

In one embodiment there is a golf ball rangefinder including a body configured to be gripped by a user, a laser measurement device positioned within the body and configured to emit a visible laser light to measure a distance from the golf ball rangefinder to a point where the laser light contacts an external surface, an electronic display in communication with the laser measurement device and coupled to an external surface of the body, the electronic display configured to display a visual indication of the measured distance, and the laser measurement device has an accuracy of at least +/−1.0 inch.

In some embodiments, the golf ball rangefinder further includes an attachment element coupled to the body and configured to attach the body to a flagstick. In some embodiments, the attachment element includes a carabiner. In some embodiments, the golf ball rangefinder further includes a ball marker magnetically coupled to the body. In some embodiments, the golf ball rangefinder further includes a divot tool detachably coupled to the body. In some embodiments, the emitted visible laser light is a level 3 green laser light.

In some embodiments, the golf ball rangefinder further includes, a sight extending along a length of the body, the sight configured to allow a user to look through the sight to aim the visible light emitted by the laser measurement device at a golf ball. In some embodiments, the sight has a magnification ratio of 1:1. In some embodiments, the body is generally rectangular in shape, In some embodiments, the body has a length of about 4.1 inches and a height of about 3.6 inches. In some embodiments, the body has a thickness of about one inch. In some embodiments, the laser measurement device has an accuracy of at least +/−0.5 inches.

In another embodiment there is a golf ball rangefinder including a body configured to be gripped by a user, the body having a thickness of about one inch, a laser measurement device positioned within the body and configured to emit a visible laser light to measure a distance from the golf ball rangefinder to a point where the laser light contacts an external surface, an electronic display in communication with the laser measurement device and coupled to an external surface of the body, the electronic display configured to display a visual indication of the measured distance, a divot tool detachably coupled to the body, a ball marker magnetically coupled to the body, and a sight extending along a length of the body, the sight configured to allow a user to look through the sight to aim the visible light emitted by the laser measurement device at a golf ball. The laser measurement device has an accuracy of at least +/−0.5 inches.

In another embodiment there is a method of measuring a distance from a golf ball to a golf ball cup during a game of closest to the pin golf game, the method includes, attaching a golf ball rangefinder to a flagstick that is positioned within the golf ball cup, the golf ball rangefinder configured to measure via laser measurement the distance from the golf ball rangefinder to the golf ball, and measuring, using the golf ball rangefinder, the distance between the golf ball and the golf ball rangefinder.

In some embodiments, the measuring occurs while the golf ball rangefinder is attached to the flagstick. In some embodiments, while measuring, the golf ball rangefinder emits a visible laser light on a surface of the golf ball. In some embodiments the method further includes displaying, on a screen of the golf ball rangefinder, a visual indication of the measured distance between the golf ball and the golf ball rangefinder. In some embodiments, the measuring is within an accuracy of +/−0.5 inches.

In another embodiment there is a method of measuring the distance from a golf ball to a golf ball cup, the method including measuring a distance between a golf ball and a golf ball cup using a golf ball rangefinder having a laser measurement device configured to determine the distance with an accuracy of +/−0.5 inches.

### BRIEF DESCRIPTION OF THE DRAWINGS

The following detailed description of embodiments of the golf rangefinder, will be better understood when read in conjunction with the appended drawings of exemplary embodiments. It should be understood, however, that the invention is not limited to the precise arrangements and instrumentalities shown.

In the drawings:

FIG. 1 is a rear perspective view of a golf rangefinder in accordance with an exemplary embodiment of the present disclosure;

FIG. 2 is a front perspective view of the golf rangefinder of FIG. 1;

FIG. 3 is a side elevational view of the golf rangefinder of FIG. 1;

FIG. 4 is a front elevational view of the golf rangefinder of FIG. 1;

FIG. 5 is a side perspective view of the golf rangefinder of FIG. 1 showing a divot tool decoupled from the golf rangefinder;

FIG. 6 is a magnified view of the golf rangefinder of FIG. 1;

FIG. 7 is a rear perspective view of a golf rangefinder in accordance with another exemplary embodiment of the present disclosure;

FIG. 8 is a use case diagram illustrating a method of measuring a distance from a golf ball to a golf ball cup during a game of closest to the pin golf game in accordance with an exemplary embodiment of the present disclosure; and

FIG. 9 is a use case diagram illustrating another method of measuring a distance from a golf ball to a golf ball cup during a game of closest to the pin golf game in accordance with another exemplary embodiment of the present disclosure.

### DETAILED DESCRIPTION

Golf rangefinders are typically used by players to estimate the distance from a tee box to a green and/or the fairway to the green. Existing golf rangefinders often employ laser measurement devices capable of estimating the distance from the rangefinder to a point in space that is typically far away (e.g., over 100 yards in distance). The minimum and maximum measurement distance of such rangefinders is typically in the order of yards (e.g., about 5 yards minimum and about 1,300 yards maximum). Because conventional golf rangefinders are configured to be used to measure long distances, they are often only accurate within about a yard, two yards, three yards, and so on. As such, conventional golf rangefinders are not usable to accurately estimate shorter distances such as the distance from a golf ball to a golf ball cup/flagpole when the golf ball is close to or on the green (e.g., when the player would be putting). For example, when a player's golf ball is on the green, the distance from the golf ball to the golf ball cup, or golf ball hole, can be up to about sixty feet. As such, it may be beneficial for the player to accurately estimate (e.g., estimate within about +/−1.0 inches) the distance from their golf ball to the golf ball cup. As such, there is a need to provide a golf rangefinder capable of easily allowing a user (e.g., a player) to accurately measure the distance between their golf ball and a golf ball cup when the golf ball is located on or proximate to the green.

Additionally, existing golf rangefinders are typically too thick or bulky to be comfortably placed in a player's pants or shorts pockets. This may make it difficult or cumbersome for a player to bring an existing rangefinder onto the green along with other devices or sporting equipment such as, but not limited to, a putter, golf ball marker, and/or divot tool. As such, there is a need to provide a golf rangefinder sized to fit comfortably in a user's pocket that may include one or more attachment features for attaching other sporting equipment (e.g., golf ball marker, divot tool) thereto.

Various aspects of the present disclosure are described with reference to the sport of golf and therefore various golf specific terms are discussed herein. A “golf course” refers to a series of holes, typically nine or eighteen holes in total, each defining areas of play. A “hole” refers to an area of play including the tee box, fairway, hazards (e.g., roughs, sand traps, water traps), and putting green. A “tee box” refers to the designated area that marks the beginning of a hole. The “fairway” is a stretch of shorter grass between the tee box and putting green. The “putting green” is the area of finely trimmed grass at the end of a hole where a player putts. A “golf ball cup” or “golf ball hole” refers to the area on the putting green where a flagstick stands and where the ground has been removed to create a hole into which the player putts their golf ball. Golf ball holes are typically 4.25 inches in diameter and at least about 4.00 inches deep. A “flagstick”, alternatively referred to as a “flagpole” or “pin”, may refer to a staff that is positioned within a golf ball hole and extends outwardly therefrom marking the location of the golf ball hole on the putting green. A flagpole is understood herein to extend outwardly from generally the center of a golf ball cup. A “golf ball” is a ball designed to be used in the game of golf and may have a diameter not less than 1.680 inches and a mass not greater than 1.620 ounces. A “user” may refer to any person operating the golf rangefinder of the present disclosure, which in some instances may be a player or participant in a golf sporting event or generally a person playing or participating in the play of golf.

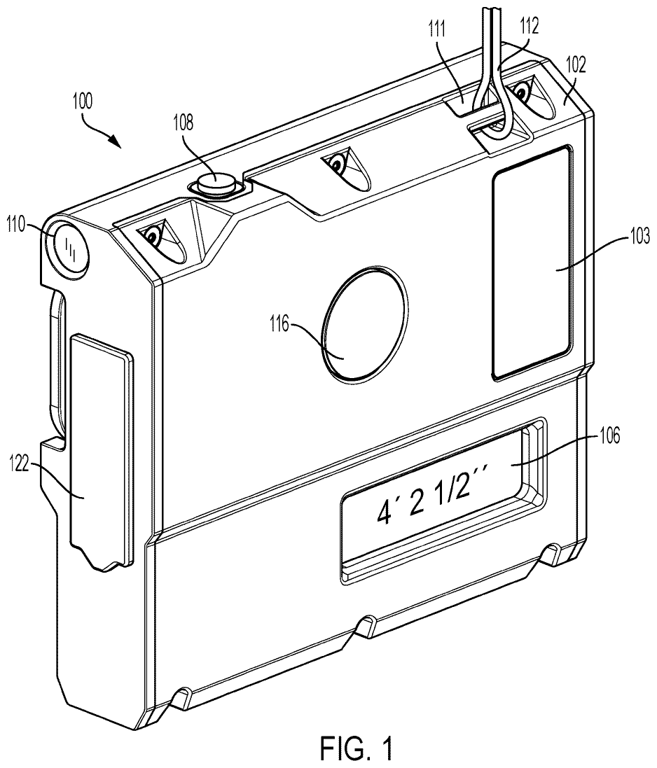

Referring to the drawings in detail, wherein like reference numerals indicate like elements throughout, there is shown in FIGS. 1-6 a golf rangefinder, generally designated 100, and referred to as rangefinder 100 for short, in accordance with an exemplary embodiment of the present invention. The golf rangefinder 100 may be configured to measure the distance between a golf ball and a golf ball cup with an accuracy of about +/−1.00 inches and, in some embodiments, with an accuracy of about +/−0.50 inches. The golf rangefinder 100 may be sized to comfortably fit within a user's pocket such that the user may easily bring the golf rangefinder 100 onto a putting green for use and store the rangefinder in their pocket when not in use. In some embodiments, the golf rangefinder 100 may include one or more attachment features for attaching the rangefinder 100 onto a flagstick on the putting green to reliably gather accurate measurements of distances between the flag stick and one or more golf balls on the green.

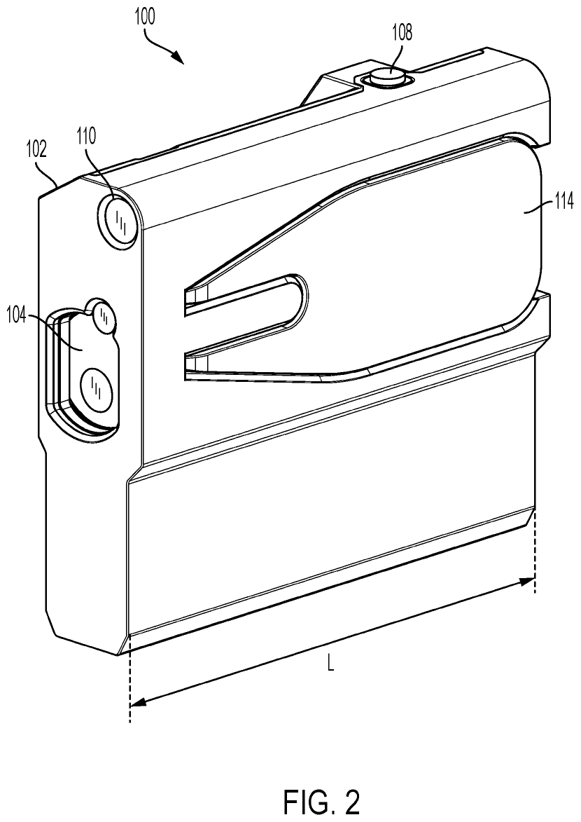

Referring to FIGS. 1-2, the golf rangefinder 100 may include a body 102 configured to be gripped by a user, a laser measurement device 104 configured to measure the distance between a desired object and the rangefinder 100, and an electronic display 106 coupled to the body 102 and configured to display a visual indication of the measurement generated by the laser measurement device 104. The laser measurement device 104 may be communicatively coupled to the electronic display 106 such that data generated by the laser measurement device 104 (e.g., measurement data) may be transmitted to the electronic display 106. In some embodiments, the golf rangefinder 100 includes one or more computing devices (e.g., a controller) having one or more processors and memory (e.g., one or more nonvolatile storage devices). In some embodiments, memory or computer readable storage medium of memory stores programs, modules and data structures, or a subset thereof for a processor to control the aspects of the rangefinder 100 and methods of use thereof disclosed herein. In some embodiments, there is a power source (not shown) electrically coupled to the laser measurement device 104 and electronic display 106 and configured to provide power to both. In some embodiments, the power source may be a detachable power source (e.g., batteries). In other embodiments, the power source may be a rechargeable power source.

In some embodiments, the rangefinder 100 includes an internal chassis (not shown) for structurally supporting components of the rangefinder 100. For example, processors, memory modules, power sources, electrical wiring, substrates for conveying electrical signals (e.g., printed circuit boards), the laser measurement device 104, and other components of the rangefinder 100 housed within the body 102 may be mounted to the internal chassis. In some embodiments, by providing an internal chassis, the durability of the rangefinder 100 may be improved. The body 102 may entirely enclose the internal chassis such that the internal chassis is not visible to a user. In some embodiments, the body 102 is mounted to the chassis. In some embodiments, the body 102 is comprised of two separate covers connected to one another. For example, the body 102 may include a first covering and a second covering that when connected to one another entirely encapsulate the internal chassis.

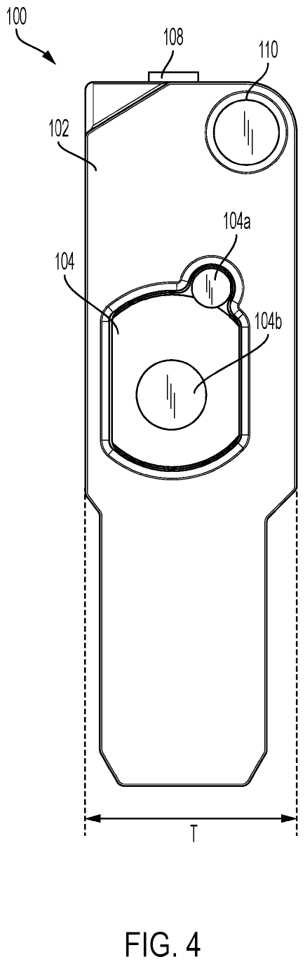

The laser measurement device 104 may be configured to measure the distance between a targeted object and the laser measurement device 104. For example, the laser measurement device 104 may emit a laser beam, or laser light, that is reflected off of a targeted objects surface and returns to the laser measurement device 104. As shown in FIG. 4, the laser measurement device 104 may include a first lens 104a and a second lens 104b for emitting a laser beam and receiving the reflected laser beam. For example, the laser measurement device 104 may be configured to emit a laser beam through the first lens 104a such that when the laser beam is reflected off of a surface, the laser beam passes through the second lens 104b, or vice versa. The laser measurement device 104 may be configured to, based on the reflected laser beam, determine a measured distance between the target object and the laser measurement device 104. In some embodiments, the rangefinder 100 of the present disclosure may be configured to provide more accurate distance measurements when compared to conventional golf rangefinders.

In some embodiments, the laser measurement device 104 has an accuracy of at least +/−1.0 inch. For example, the distance between the rangefinder 100 and a target object (e.g., a flagstick, a golf ball) as measured by the laser measurement device 104 may be accurate within +/−about 2.0 inches, about 1.8 inches, about 1.5 inches, about 1.2 inches, about 1.0 inch, about 0.9 inches, about 0.8 inches, about 0.7 inches, about 0.6 inches, about 0.5 inches, about 0.4 inches, about 0.3 inches, about 0.2 inches, or about 0.1 inches. In some embodiments, the laser measurement device 104 has an accuracy of at least +/−0.5 inches. In this manner, the rangefinder 100 of the present disclosure may be configured to more accurately measure a desired distance than a conventional golf rangefinder. For example, conventional golf rangefinders are typically only accurate by about +/−1.0 yards whereas the rangefinder 100 of the present disclosure has an accuracy of at least +/−1.0 inch, and in some embodiments +/−0.5 inches. In this manner, the golf rangefinder 100 of the present disclosure may significantly improve a user's ability to accurately determine (e.g., within at least +/−1.0 inch) the distance between a golf ball and the golf ball cup. This may be particularly beneficial when a user wishes to determine the distance for a putt and/or when determining which golf ball, of a plurality of golf balls on a putting green are closest to the golf ball cup (e.g., during a game of closest to the pin).

In some embodiments, the laser measurement device 104 is configured to emit a laser light that is visible to the human eye. For example, the laser measurement device 104, when activated, may emit a level 3 green laser light. In this manner, a user may be able to visually determine the object and/or surface for which the distance is currently being measured. For example, a user may position the rangefinder 100 proximate a flagstick on a putting green, orient the rangefinder 100 at a golf ball and activate the laser measurement device 104 to cause a visible laser light to appear on the surface of the golf ball. In some embodiments, the rangefinder 100 includes a warning label 103 applied to a surface of the body 102 proximate the laser measurement device 104 to warn the user about risks associated with the use of the laser measurement device 104 (e.g., damage to eyesight).

In some embodiments, the laser measurement device 104 is configured to be selectively activated by a user. For example, the rangefinder 100 may include a user-operable button 108 in communication with the laser measurement device 104. A user may interact with (e.g., press) the button 108 to cause the laser measurement device 104 to activate and thereby emit a laser beam. Although the user-operable button 108 is illustrated in the figures as being a depressible button, it will be understood that the user-operable button 108 may be any form of user input device, such as, but not limited to, a switch, a trigger, a pressure sensor or any other suitable user input device.

In some embodiments, rangefinder 100 includes a heat transfer device (not shown) for cooling the laser measurement device 104. For example, there may be one or more vents or screens formed along portions of the body 102 for permitting airflow to the laser measurement device 104 housed within the body 102. In some embodiments, the rangefinder 100 includes one or more fans and/or heat fins for directing airflow to and from the laser measurement device 104.

The electronic display 106 may be configured to display thereon a visual indication of a distance measured by the laser measurement device 104. For example, when activated, the laser measurement device 104 may generate measurement data corresponding to a measured distance between the laser measurement device 104 and a target object or surface. The generated measurement data may be transmitted to the electronic display 106. In response to receiving the generated measurement data, the electronic display 106 may display indicia corresponding to the generated measurement data. For example, the laser measurement device 104 may generate measurement data indicating that a target object is about four feet and two and a half inches away and the electronic display 106 may have displayed thereon text indicating that measured value, as illustrated, for example in FIG. 1. In some embodiments, the placement, size and/or shape of the electronic display 106 may be different from what is illustrated in FIGS. 1 and 4. For example, the electronic display may be disposed on a different surface of the body 102 and/or be pill shaped or circular in shape.

In some embodiments, the rangefinder 100 may include a sight 110 configured to allow a user to look through the sight 110 to aim the visible laser light emitted by the laser measurement device 104 at a desired object and/or surface. For example, the sight 110 may generally act as a sighting device to assist a user looking therethrough in visually aligning the emitted visible laser light with an intended target (e.g., flagstick, golf ball, golf ball cup). The sight 110 may extend along a length L of the body 102. In some embodiments, the sight 110 includes one or more transparent surfaces and/or lenses disposed at opposite ends of the sight 110. For example, the sight 110 may include an aperture extending through the length L of the body 102 and including transparent lenses at the proximal and distal ends thereof. In other embodiments, the sight 110 does not include any transparent surfaces or lenses. In some embodiments, the sight 110 may include a reticle (e.g., crosshair, dot, star Mil-dot, SVD-type) to further assist a user in visually aligning the emitted visible laser light with an intended target. In some embodiments, the sight 110 has a magnification ratio of 1:1, or put another way, the sight 110 may have no magnification. In other embodiments, the sight 110 has a magnification ratio of at least 2:1. In other embodiments, the sight 110 has a magnification ratio of about 1:2. In some embodiments, the sight 110 may have a diameter of between about 0.6 inches to about 0.2 inches. In some embodiments, diameter of the sight is about 0.3 inches.

In some embodiments, the rangefinder 100 may be configured to receive an attachment element for connecting the rangefinder 100 to an object and/or user. The rangefinder 100 may include a receiving element 111 coupled to the body 102 and configured to receive an attachment element 112. The receiving element 111 may be a groove open at adjacent surfaces of the body 102 and including a bar extending over at least a portion of the groove. For example, and as illustrated in FIG. 1, the receiving element 111 is a groove that is open along a side surface and the adjoining top surface of the body 102. A bar extends partially along the length of the body 102 between opposed sidewalls of the groove such that the attachment element 112 may be connected thereto. For example, in FIG. 1, the attachment element 112 is a lanyard strap looped through the receiving element 111 thereby coupling the attachment element 112 to the body 102. The receiving element 111 may be disposed along any surface of combination of surfaces along the body 102. For example, in one embodiment the receiving element is a recessed groove generally the same as what is illustrated in FIG. 1 but positioned proximate the opposite corner of the body 102.

In some embodiments, the attachment element 112 is configured to couple the rangefinder to a flagstick. A user may attach the rangefinder 100 to a flagstick via the attachment element 112 to gather multiple measurements from generally the same location. For example, a user may attach the rangefinder 100 to a flagstick and measure the distance from the flagstick to one or more different golf balls each being in different locations all while the rangefinder 100 is attached to the flagstick. In some embodiments the attachment element 112 may be a carabiner. In this manner, a user may freely attach and detach the attachment element 112 to a flagstick as well as other objects such as, but not limited to, a belt loop, a golf bag, backpack, purse, an article of clothing (e.g., a belt) and/or the user (e.g., the user's neck). In other embodiments, the attachment element 112 is configured to fixedly couple the rangefinder 100 to a flagstick.

In some embodiments, the rangefinder 100 is configured to be coupled to an external device that is coupled to a flagstick. For example, there may be a mounting device coupled to the flagstick and configured to receive the rangefinder 100. The body 102 of the rangefinder 100 may include one or more attachment features configured to be mounted to corresponding attachment features of the flagstick mounting device. In this manner, the rangefinder 100 may be detachably coupled to the flagstick via the mounting device. The rangefinder 100 may be configured to selectively enable the laser measurement device 104 based on whether the body 102 is coupled to the flagstick mounting device. For example, the rangefinder 100 and/or flagstick mounting device may include one or more sensors such that the rangefinder 100 may determine whether the body 102 is coupled to the flagstick mounting device. In response to determining that the body 102 is coupled to the flagstick mounting device, the rangefinder 100 may enable the laser measurement device 104 such that a user may activate the measurement device 104. Similarly, in response to determining that the body 102 is not coupled to the flagstick mounting device, the rangefinder 100 may be configured to disable the laser measurement device 104 such that a user may not activate the measurement device 104.

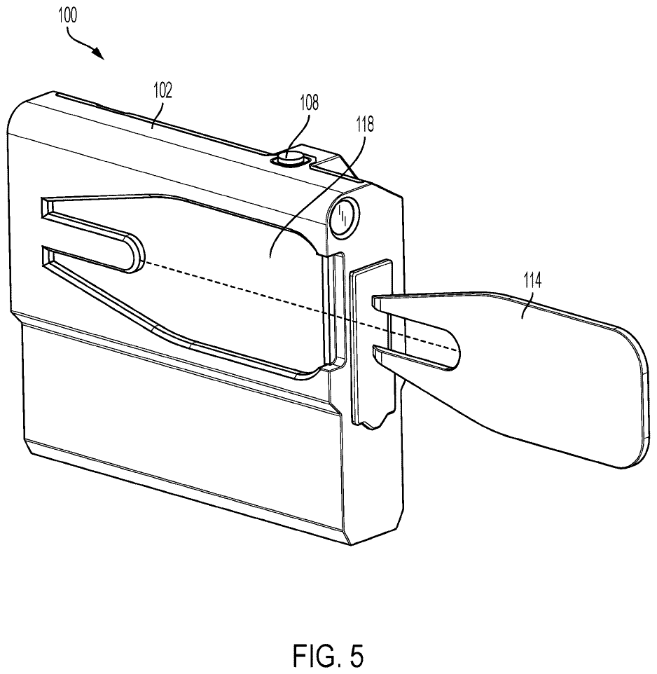

Referring to FIGS. 1 and 5, in some embodiments, the rangefinder 100 may be configured to have coupled thereto one or more sporting equipment devices. For example, in some embodiments the rangefinder 100 may include sporting equipment relating to golf play on a putting green, such as, but not limited to a divot tool 114 and/or a ball marker 116. In some embodiments, the divot tool 114 is detachably coupled to the body 102. For example, the body 102 may include a receiving area 118 for detachably coupling the divot tool 114 to the body 102. In some embodiments, the ball marker 116 (e.g., a golf ball marker) may be detachably coupled to the body 102. For example, the ball marker 116 may be magnetically coupled to the body 102 as illustrated in FIG. 1. In other embodiments, the ball marker 116 is magnetically coupled to the divot tool 114. In some embodiments, the ball marker 116 of the rangefinder 100 may include indicia, images, embossing and/or text intended to be displayed to a user. For example, the ball marker 116 may include a brand logo either printed on or etched onto a front surface thereof. In some embodiments, the ball marker 116 may include a transparent outer covering behind which one or more articles for display may be positioned and retained. In other embodiments, the ball marker 116 may be replaced with an analog display including a detachable transparent outer covering behind which one or more articles for display may be positioned and retained. For example, a brand logo may be placed between the body 102 and the transparent outer covering of the analog display area thereby retaining the logo in place. In some embodiments, the ball marker 116 may be replaced with a digital display area configured to display indicia to the user.

In some embodiments, the rangefinder 100 may include a surface attachment feature (not shown) for attaching the rangefinder 100 to an external surface. In some embodiments, the surface additional attachment may be a magnet coupled to the body 102 and configured to detachably couple the rangefinder 100 to a metal surface (e.g., a surface comprising a ferromagnetic material). For example, the magnetic surface attachment feature may allow a user to magnetically couple the rangefinder 100 to a metal surface on a golf cart. In some embodiments, the surface attachment feature is coupled to a side surface of the body 102. In some embodiments, the surface attachment feature is embedded within the body 102 such that it is not visible to a user when observing the rangefinder 100.

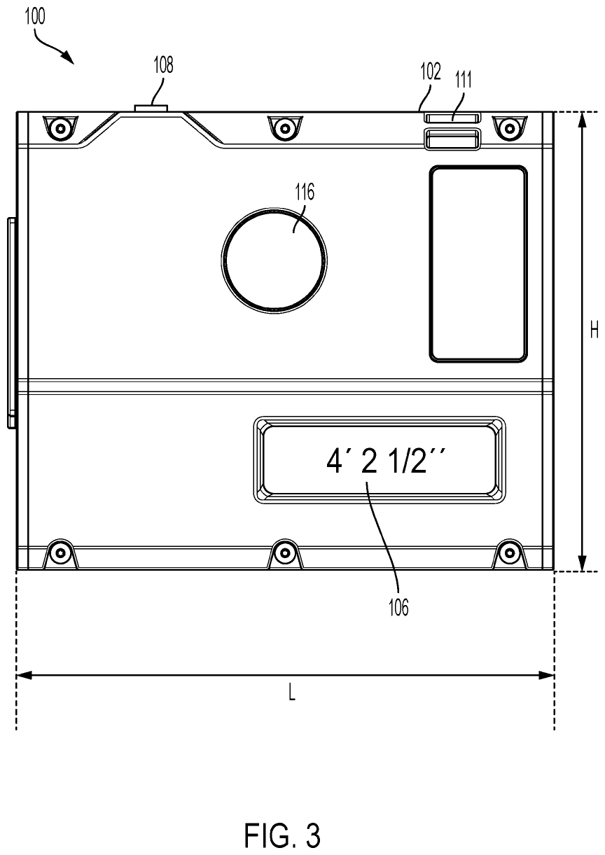

Referring to FIGS. 3-4, the rangefinder 100 may be sized to comfortably fit into a user's pocket such that the user may easily bring the rangefinder 100 onto a putting green and store the rangefinder 100 when not in use. For example, the body 102 may have a length L of between about 2.0 inches to about 6.0 inches. In some embodiments, the length L is between about 3.5 to about 4.5 inches. In some embodiments the length L is about 3.5 inches, about 3.6 inches, about 3.7 inches, about 3.8 inches, about 3.9 inches, about 4.0 inches, about 4.1 inches, or about 4.2 inches. In some embodiments, the length L is about 4.185 inches. The body 102 may have a height H of between about 2.0 inches to about 6.0 inches. In some embodiments, the height H is between about 3.5 inches to about 4.5 inches. In some embodiments, the height H is about 3.0 inches, about 3.1 inches, about 3.2 inches, about 3.3. inches, about 3.4 inches, about 3.5 inches, about 3.6 inches or about 3.7 inches. In some embodiments, the body 102 may have a thickness T that is less than 1.0 inch. In some embodiments, the thickness T is between about 0.5 inches to about 1.5 inches. In some embodiments, the thickness T is about 0.7 inches, about 0.8 inches, about 0.9 inches, or about 1.0 inch. In some embodiments, the body 102 has a length L of about 4.1 inches, a height H of about 3.6 inches, and a thickness T of about 1.0 inch. In some embodiments, the body 102 has a length L of about 3.9 inches, a height H of about 3.2 inches, and a thickness T of about 0.9 inches. In some embodiments, the body 102 is generally rectangular in shape when viewed from the side (e.g., as shown in FIG. 3). In other embodiments, the body 102 may be generally square in shape. In some embodiments, the body 102 may be curved to fit comfortably in a pocket (e.g., a back pocket) of an article of clothing worn by a user. For example, the body 102 may be curved along the length L and/or height H such that one side surface is generally concave in shape and an opposite side surface is generally convex in shape (e.g., similar to a flask shape) to enable the rangefinder 100 to roughly contour to a user's body when carried within in a back pant/shorts pocket or other garment pocket.

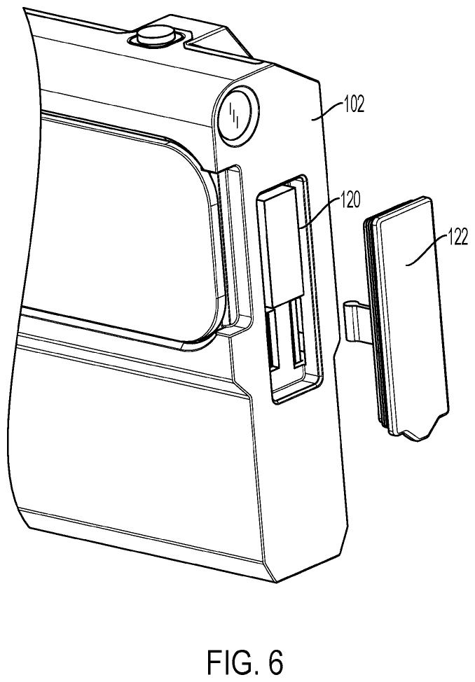

Referring to FIGS. 1 and 6, the rangefinder 100 may include a receiving port 120 configured to electrically couple an interface device (e.g., a charging cable, data transfer cable) to the rangefinder 100. For example, the receiving port 120 may be a universal serial bus (USB) port configured to receive a corresponding USB cable that when connected to the receiving port 120 allows for data and/or electrical power to be transferred to and/or from the rangefinder 100. In some embodiments, the receiving port 120 includes at least one data port and at least one power port. In some embodiments, the receiving port 120 includes a single port configured to transfer data and electrical power. In some embodiments, the receiving port 120 includes a cover 122 coupled to the body 102 and configured to prevent debris from contacting the receiving port 120. The cover 122 may be comprised of a rubber or rubber-like material and may be sized to cover the exterior surface of the receiving port 120.

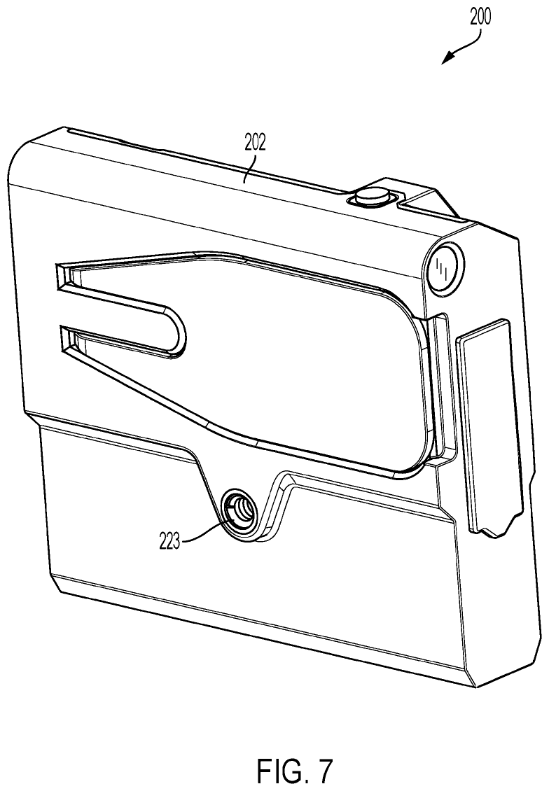

Referring to FIG. 7, there is shown a golf rangefinder, generally designated 200, in accordance with an exemplary embodiment of the present disclosure. The rangefinder 200 may be substantially the same as rangefinder 100 discussed above except that the rangefinder 200 may include a second receiving element 223 positioned along the rear surface of the body 202. The receiving element 223, in some embodiments, is a threaded aperture extending partially through the body 202. The receiving element 223 may enable the rangefinder 200 to be securely connected to an external mounting device or hardware such as a portable frame or stand (e.g., a tripod stand).

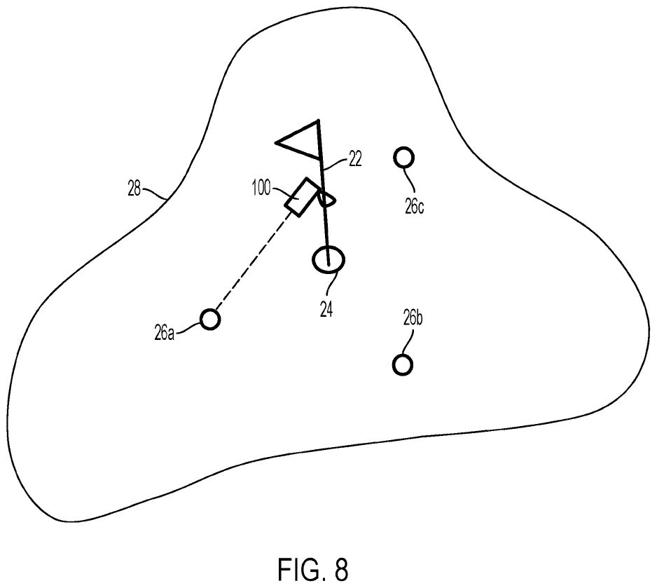

Referring to FIG. 8, there is illustrated a use case of a method of measuring a distance from a golf ball to a golf ball cup during a game of closest to the pin in accordance with an exemplary embodiment of the present disclosure. The method may include, attaching a golf rangefinder (e.g., golf ball rangefinder 100, golf ball rangefinder 200) to a flagstick 22 that is positioned within a golf ball cup 24. For example, the rangefinder 100 may be attached to the flagstick 22 via the attachment element 112 discussed above. The method may further include, measuring, using the golf rangefinder 100, the distance between a golf ball and the golf rangefinder 100. For example, in FIG. 6 there are three golf balls 26a-26c illustrated as being positioned on a putting green 28. A user may orient the golf rangefinder 100 at the first golf ball 26a and activate the laser measurement device 104 to cause the laser measurement device 104 to measure the distance between the rangefinder 100 and the first golf ball 26a. In some embodiments, measuring the distance between the rangefinder 100 and the first golf ball 26a occurs while the rangefinder 100 is attached to the flagstick 22. The user may repeat this process for each of the second golf ball 26b and third golf ball 26c to determine which of the golf balls 26a-26c is the closest to the golf ball cup 24 and/or flagstick 22 (e.g., the “pin”). In this manner, the rangefinder 100 of the present disclosure may enable a user to quickly and accurately measure the distances between a golf ball cup and a plurality of golf balls to determine which of the golf balls is the closes to the golf ball cup.

In some embodiments, a reflective material, surface and/or object may be used to determine the distance between the range finder and at least one of the golf balls 26a-26c. For example, a reflector or golf ball marker having a reflective surface may be placed generally at the location of the golf ball 26a and the user may orient the rangefinder 100 at the reflector or golf ball marker to measure the distance between the rangefinder and first golf ball 26a. In this manner, the rangefinder 100 of the present disclosure may be used in high light/lux environments by leveraging a reflective surface of the reflector to aid in performing a measurement with the measurement device 104.

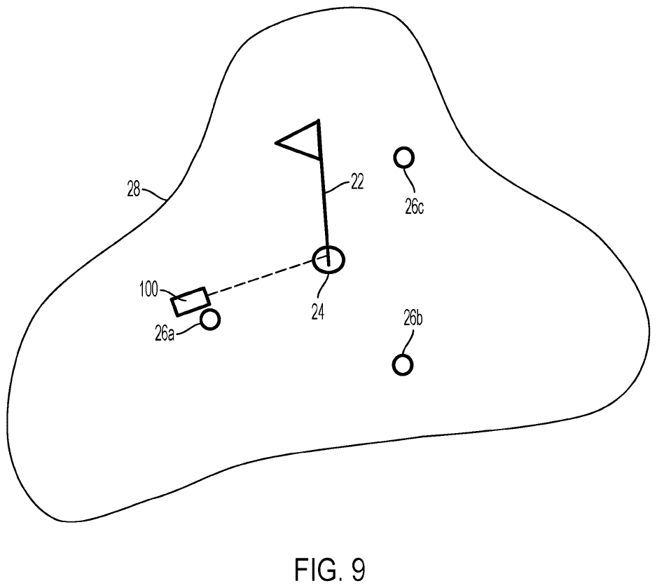

Referring to FIG. 9, there is shown another use of another method of measuring a distance from a golf ball to a golf ball cup during a game of closest to the pin in accordance with an exemplary embodiment of the present disclosure. The method may be generally the same as discussed above with reference to FIG. 8, except that the rangefinder 100 is positioned proximate a specific golf ball. For example, in FIG. 9, the rangefinder 100 is positioned proximate a first golf ball 26a and oriented toward the flagstick 22 or golf ball cup 24. The user may activate the measurement device 104 to cause the measurement device to emit the visible laser light on a surface of the flagstick 22 or golf ball cup 24 while the rangefinder 100 is proximate the golf ball 26a (e.g., generally directly above or adjacent to the golf ball 26a). The user may repeat this process for each of the remaining golf balls 26b-26c in order to determine which of the golf balls 26a-26c is closest to the golf ball cup 24.

In some embodiments, the rangefinder 100 is configured to store data relating to one or more measured distances from one or more golf balls to a golf ball cup. For example, in response to measuring, via the laser measurement device 104, a distance from a golf ball to a golf ball cup, or any other measured distance, the rangefinder 100 may automatically generate and store data indicating the measured distance. The rangefinder 100 may be configured to generate and store data for a plurality of measurements. In some embodiments, the rangefinder 100 may be configured to associate the generated measurement data with one or more golf course holes and/or players. For example, the rangefinder 100 may receive one or more user inputs including an indication of the hole on a golf course a user started on and/or the number of players in a group with the user. The rangefinder 100 may determine, based on the user's activation of the laser measurement device 104 at different points in time, which hole and/or which player the measurement is associated with. For example, if the user inputs include an indication that the user is starting play on the third hole of a golf course and that there are 2 other players in the user's group, the rangefinder 100 may automatically associate the first three measurements with each of the three total players (e.g., the user and the additional two players) and the third hole. Further to this example, the rangefinder 100 may automatically associate the next three measurements with each of the three total players and the fourth hole, and so on for each set of three measurements. In some embodiments, the rangefinder 100 is configured to receive user input indicating that the user wishes to overwrite previously generated measurement data. For example, the user may perform an initial measurement and may desire to retake the measurement (e.g., due to incorrect aiming of the measurement device 104). As such, the user may provide an input to cause the rangefinder 100 to delete and/or update the measurement data generated with new measurement data generated from a proceeding measurement.

In some embodiments, the rangefinder 100 may be configured to automatically determine a ranking of measured distance from a plurality of measured distances. For example, and referring to FIGS. 6 and 7, the rangefinder 100 in response to determining the measured distances from the golf balls 26a-26c to the golf ball cup 24 may automatically determine that the measured distance for golf ball 26a is the greatest (e.g., furthest from the pin), that golf ball 26b is closer to the pin than golf ball 26a but further from the pin than golf ball 26c and that golf ball 26c is the closest to the pin. In some embodiments, the rangefinder 100 is configured to associate the generated measurement data with one or more specific times. For example, the rangefinder 100 may automatically store data indicating the time (e.g., year, month, day, time of day) that a measurement was generated. As such, the rangefinder 100 may be configured to determine average measured distances per hole, per round of golf, and/or per season or year for one or more players.

In some embodiments, the rangefinder 100 may automatically transmit the generated data to an external device in communication with the rangefinder 100. The rangefinder 100 may include one or more wireless or wired communication means (e.g., a Bluetooth® device) such that measurement data generated and stored thereon may be transmitted to an external device. For example, the rangefinder 100 may include a wireless communication device for transmitting measured putting distance values to a smartphone such that the transmitted values may be automatically synchronized with a mobile software application. In this manner, the external device may automatically receive data from a plurality of rangefinders 100 and aggregate the data at a central location. Furthermore, this may be particularly beneficial in golf tournaments or competitions where multiple groups or players are participating in play at one or more different locations on the golf course at different or the same time. For example, rangefinders 100 used by different users at different holes on the course may automatically transmit the generated measurement data which may be aggregated at an external device (e.g., a computer system a club house at the golf course) such that closest to the pin measurements for each player is aggregated to determine current rankings and/or a winner automatically.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. Finally, unless specifically set forth herein, a disclosed or claimed method should not be limited to the performance of their steps in the order written, and one skilled in the art can readily appreciate that the steps may be performed in any practical order. When specifying a numerical value or range of values, the term “about” means +/−10% unless otherwise defined.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

1. A golf ball rangefinder comprising:
a body configured to be gripped by a user;
a laser measurement device positioned within the body and configured to emit a visible laser light to measure a distance from the golf ball rangefinder to a point where the laser light contacts an external surface; and
an electronic display in communication with the laser measurement device and coupled to an external surface of the body, the electronic display configured to display a visual indication of the measured distance,
wherein the laser measurement device has an accuracy of at least +/−1.0 inch.

2. The golf ball rangefinder of claim 1 further comprising:
a flagstick attachment element coupled to the body and configured to attach the body to a flagstick.

3. The golf ball rangefinder of claim 2, wherein the flagstick attachment element includes a carabiner.

4. The golf ball rangefinder of claim 1 further comprising:
a ball marker magnetically coupled to the body.

5. The golf ball rangefinder of claim 1 further comprising:
a divot tool detachably coupled to the body.

6. The golf ball rangefinder of claim 1, wherein the emitted visible laser light is a level 3 green laser light.

7. The golf ball rangefinder of claim 1 further comprising:
a sight extending along a length of the body, the sight configured to allow a user to look through the sight to aim the visible light emitted by the laser measurement device at a golf ball.

8. The golf ball rangefinder of claim 7, wherein the sight has a magnification ratio of 1:1.

9. The golf ball rangefinder of claim 1, wherein the body is generally rectangular in shape.

10. The golf ball rangefinder of claim 1, wherein the body has a length of about 3.9 inches and a height of about 3.2 inches.

11. The golf ball rangefinder of claim 10, wherein the body has a thickness less than one inch.

12. The golf ball rangefinder of claim 1, wherein the laser measurement device has an accuracy of at least +/−0.5 inches.

13. A golf ball rangefinder comprising:
a body configured to be gripped by a user, the body having a thickness of less than one inch;
a laser measurement device positioned within the body and configured to emit a visible laser light to measure a distance from the golf ball rangefinder to a point where the laser light contacts an external surface;
an electronic display in communication with the laser measurement device and coupled to an external surface of the body, the electronic display configured to display a visual indication of the measured distance;
a divot tool detachably coupled to the body;
a ball marker magnetically coupled to the body; and
a sight extending along a length of the body, the sight configured to allow a user to look through the sight to aim the visible light emitted by the laser measurement device at a golf ball,
wherein the laser measurement device has an accuracy of at least +/−0.5 inches.

14. A method of measuring a distance from a golf ball to a golf ball cup during a game of closest to the pin golf game, the method comprising:
attaching a golf ball rangefinder to a flagstick that is positioned within the golf ball cup, the golf ball rangefinder configured to measure via laser measurement the distance from the golf ball rangefinder to the golf ball; and
measuring, using the golf ball rangefinder, the distance between the golf ball and the golf ball rangefinder.

15. The method of claim 14 where the measuring occurs while the golf ball rangefinder is attached to the flagstick.

16. The method of claim 14, wherein while measuring, the golf ball rangefinder emits a visible laser light on a surface of the golf ball.

17. The method of claim 14 further comprising:
displaying, on a screen of the golf ball rangefinder, a visual indication of the measured distance between the golf ball and the golf ball rangefinder.

18. The method of claim 14, wherein the measuring is within an accuracy of +/−0.5 inches.

19. (canceled)
